(19) United States
(12) Patent Application Publication
(10) Pub. No.: US 2016/0317912 A1
(43) Pub. Date: Nov. 3, 2016

(54) Space Anatomy

(71) Applicant: Thomas M. Relyea, Brooklyn, NY (US)

(72) Inventor: Thomas M. Relyea, Brooklyn, NY (US)

(73) Assignee: Thomas Relyea, Brooklyn, NY (US)

(21) Appl. No.: 15/093,216

(22) Filed: May 2, 2016

(30) Foreign Application Priority Data
May 1, 2015 (US) 62149843

(51) Int. Cl. A63F 13/00

(52) U.S. Cl. CPC A63F 13/00

(57) ABSTRACT

This brief description involves the filing of a non-provisional patent application for Space Anatomy; a virtual miniaturized space ship which flies through the human body. The Space Anatomy game takes the player through a myriad of medical evolution and teaches the gamer all aspects of fighting germs, bacterias, viruses and diseases. In an effort to save the human organism, the gamer will need to fight unwanted threats that compromise the existence of the human organism. The gamer will have an arsenal of weapons to ward off any unwanted threats to provide medical needs to the organism; i.e, the player will disperse vitamins and nutrients for the body to sustain a heathy life.

### CROSS REFERENCE TO RELATED APPLICATIONS

This application claims benefit of U.S. Provisional application No. 62/149,843, filed 20 Apr. 2015.

### FILLED OF INVENTION

This is the specification regarding the Non-provisional patent application for my app Space Anatomy. It will explain the basic anatomy of the human body using different fundamentals of learning. The learning objectives of this action/adventure game will focus on how the body gets sick or injured as well as which vitamins and nutrients the body needs to live healthy. These objectives will be achieved by controlling a miniature space ship that travels through the body. (Claim 01). I wish to claim three ideas of the miniaturized space ship that would fly around the human body. (Claim 02) The spaceship will be using laser beams to fight off various germs, bacterias, viruses etc. (Claim 03) It will also have the ability to disperse various vitamins and nutrients throughout the body which are essential to sustaining a healthy body.

### BRIEF DESCRIPTION OF DRAWINGS

FIG. 1: The spaceship shown is flying through a healthy artery searching for various germs to fight off.

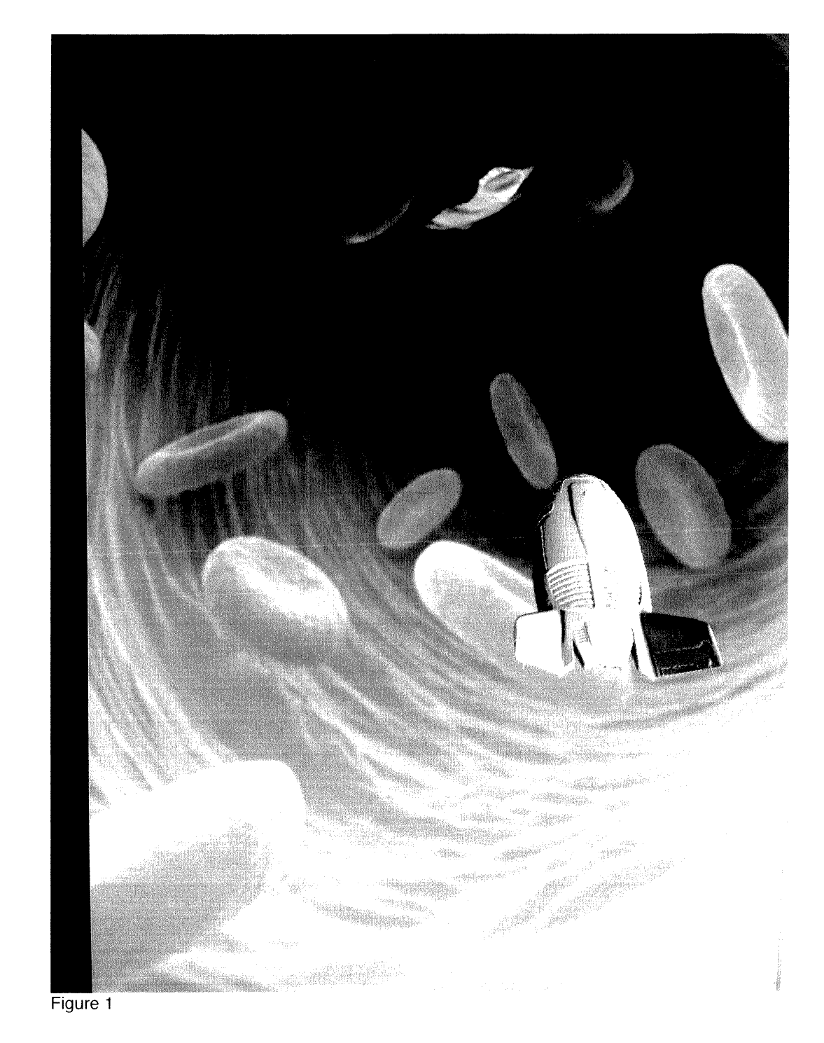

01: A video game using a miniaturized Spaceship in inside a human body.

02: Spaceship fighting off germs, bacterias, diseases etc.

03: Disperse various vitamins and nutrients threw out the body.
